(19) United States
(12) Patent Application Publication
(10) Pub. No.: US 2016/0003611 A1
(43) Pub. Date: Jan. 7, 2016

(54) ASPHERICAL SURFACE MEASUREMENT METHOD, ASPHERICAL SURFACE MEASUREMENT APPARATUS, NON-TRANSITORY COMPUTER-READABLE STORAGE MEDIUM, PROCESSING APPARATUS OF OPTICAL ELEMENT, AND OPTICAL ELEMENT

(71) Applicant: Canon Kabushiki Kaisha, Tokyo (JP)

(72) Inventor: Yasunori Furukawa, Utsunomiya-shi (JP)

(21) Appl. No.: 14/755,242

(22) Filed: Jun. 30, 2015

(30) Foreign Application Priority Data
Jul. 4, 2014 (JP) 2014-138313

(51) Int. Cl. G01B 11/24; G02B 3/02; G01M 11/02

(52) U.S. Cl. CPC G01B 11/24; G01M 11/0228; G02B 3/02; G02B 13/16

(57) ABSTRACT

An aspherical surface measurement method includes measuring a first wavefront of light from a standard surface having a known shape, measuring a second wavefront of light from an object surface having an aspherical shape, rotating the object surface around an optical axis and then measuring a third wavefront of light from the object surface, calculating error information of an optical system based on the first, second, and third wavefronts, calculating shapes of a plurality of partial regions of the object surface by using a design value of the optical system corrected based on the error information of the optical system and by using a plurality of measured wavefronts of lights from the partial regions of the object surface measured after the object surface is driven, and stitching the shapes of the partial regions of the object surface to calculate an entire shape of the object surface.

### BACKGROUND OF THE INVENTION

1. Field of the Invention

The present invention relates to an aspherical surface measurement method which measures an object surface having an aspherical shape while being divided into a plurality of partial regions and stitches them to measure an entire shape of the object surface.

2. Description of the Related Art

Previously, in order to measure an object surface having a large diameter, a stitching measurement method has been known which divides the object surface into a plurality of partial regions while providing overlapping regions (overlap regions) to measure the partial regions and then stitches measured data of each of partial regions. The stitching measurement method is capable of measuring the object surface having the large diameter by using a measurement device of an optical system having a small diameter. Therefore, compared to preparing a measurement device of an optical system having a large diameter, it is advantageous in cost and volume of an apparatus. On the other hand, in order to stitch the measured data of each partial region with high accuracy, it is necessary to remove an alignment error of the object surface contained in the measured data and a system error caused by an error of a measurement system.

Japanese Patent No. 4498672 discloses a method of evaluating a difference between measured data of an overlap region in partial regions to estimate and remove an alignment error and a system error. Japanese Patent Laid-open No. H10-281737 relates to a stitching interferometer, and discloses a method of calibrating a reference wavefront and distortion and correcting an alignment error of an object surface.

In the method disclosed in Japanese Patent No. 4498672, the system error is estimated while system errors of the measured values for all the partial regions are assumed to be the same. However, when an object to be measured has an aspherical surface having a large diameter, a position where light transmits through the optical system varies depending on the partial region and thus the system error varies. Accordingly, it is difficult to estimate the system error, and the stitching accuracy is decreased. In the method disclosed in Japanese Patent Laid-open No. H10-281737, the stitching accuracy is decreased due to the system error even when the reference wavefront and the distortion are calibrated if the object to be measured has the aspherical surface.

### SUMMARY OF THE INVENTION

The present invention provides an aspherical surface measurement method which is capable of stitching and measuring an aspherical shape having a large diameter with high accuracy, an aspherical surface measurement apparatus, a non-transitory computer-readable storage medium, a processing apparatus of an optical element, and the optical element.

An aspherical surface measurement method as one aspect of the present invention includes the steps of measuring a first wavefront of light from a standard surface having a known shape, measuring a second wavefront of light from an object surface having an aspherical shape, rotating the object surface around an optical axis and then measuring a third wavefront of light from the object surface, calculating error information of an optical system based on the first wavefront, the second wavefront, and the third wavefront, calculating shapes of a plurality of partial regions of the object surface by using a design value of the optical system corrected based on the error information of the optical system and by using a plurality of measured wavefronts of lights from the partial regions of the object surface measured after the object surface is driven, and stitching the shapes of the partial regions of the object surface to calculate an entire shape of the object surface.

An aspherical surface measurement method as another aspect of the present invention includes the steps of measuring a first wavefront of light from a first standard surface having a first known shape, measuring a second wavefront of light from a second standard surface having a second known shape, calculating error information of an optical system based on the first wavefront and the second wavefront, calculating shapes of a plurality of partial regions of the object surface by using a design value of the optical system corrected based on the error information of the optical system and by using a plurality of measured wavefronts of lights from the partial regions measured after the object surface is driven, and stitching the shapes of the partial regions of the object surface to calculate an entire shape of the object surface.

An aspherical surface measurement apparatus as another aspect of the present invention includes a detection unit configured to detect a wavefront of light, a drive unit configured to rotate an object surface around an optical axis, and a calculation unit configured to calculate a shape of the object surface based on an output signal of the detection unit, and the calculation unit is configured to measure a first wavefront as a wavefront of light from a standard surface having a known shape, measure a second wavefront as a wavefront of light from the object surface having an aspherical shape, measure a third wavefront as a wavefront of light from the object surface rotated by the drive unit, calculate error information of an optical system based on the first wavefront, the second wavefront, and the third wavefront, calculate shapes of a plurality of partial regions of the object surface by using a design value of the optical system corrected based on the error information of the optical system and by using a plurality of measured wavefronts of lights from the partial regions of the object surface measured after the object surface is driven, and stitches the shapes of the partial regions of the object surface to calculate an entire shape of the object surface.

An aspherical surface measurement apparatus as another aspect of the present invention includes a detection unit configured to detect a wavefront of light, and a calculation unit configured to calculate a shape of the object surface based on an output signal of the detection unit, and the calculation unit is configured to measure a first wavefront as a wavefront of light from a first standard surface having a first known shape, measure a second wavefront as a wavefront of light from a second standard surface having a second known shape, calculate error information of an optical system based on the first wavefront and the second wavefront, calculating shapes of a plurality of partial regions of the object surface by using a design value of the optical system corrected based on the error information of the optical system and by using a plurality of measured wavefronts of lights from the partial regions of the object surface measured after the object surface is driven, and stitching the shapes of the partial regions of the object surface to calculate an entire shape of the object surface.

A non-transitory computer-readable storage medium as another aspect of the present invention stores a program to cause a computer to execute the aspherical surface measurement method.

A processing apparatus of an optical element as another aspect of the present invention includes the aspherical surface measurement apparatus, and a processing device configured to process the optical element based on information output from the aspherical surface measurement apparatus.

An optical element as another aspect of the present invention is manufactured by using the processing apparatus of the optical element.

Further features and aspects of the present invention will become apparent from the following description of exemplary embodiments with reference to the attached drawings.

### BRIEF DESCRIPTION OF THE DRAWINGS

FIG. 1 is a schematic configuration diagram of an aspherical surface measurement apparatus in Embodiment 1.

FIG. 2 is a flowchart of illustrating a calibration process in an aspherical surface measurement method in Embodiment 1.

FIG. 3 is a flowchart of illustrating s stitching measurement process in the aspherical surface measurement method in Embodiment 1.

FIG. 4 is a schematic diagram of partial measurement regions divided when measuring an object surface in Embodiment 1.

FIG. 5 is a schematic configuration diagram of an aspherical surface measurement apparatus in Embodiment 3.

FIG. 6 is a flowchart of illustrating a calibration process in an aspherical surface measurement method in Embodiment 3.

FIG. 7 is a schematic configuration diagram of a processing apparatus of an optical element in Embodiment 4.

### DESCRIPTION OF THE EMBODIMENTS

Exemplary embodiments of the present invention will be described below with reference to the accompanied drawings.

### Embodiment 1

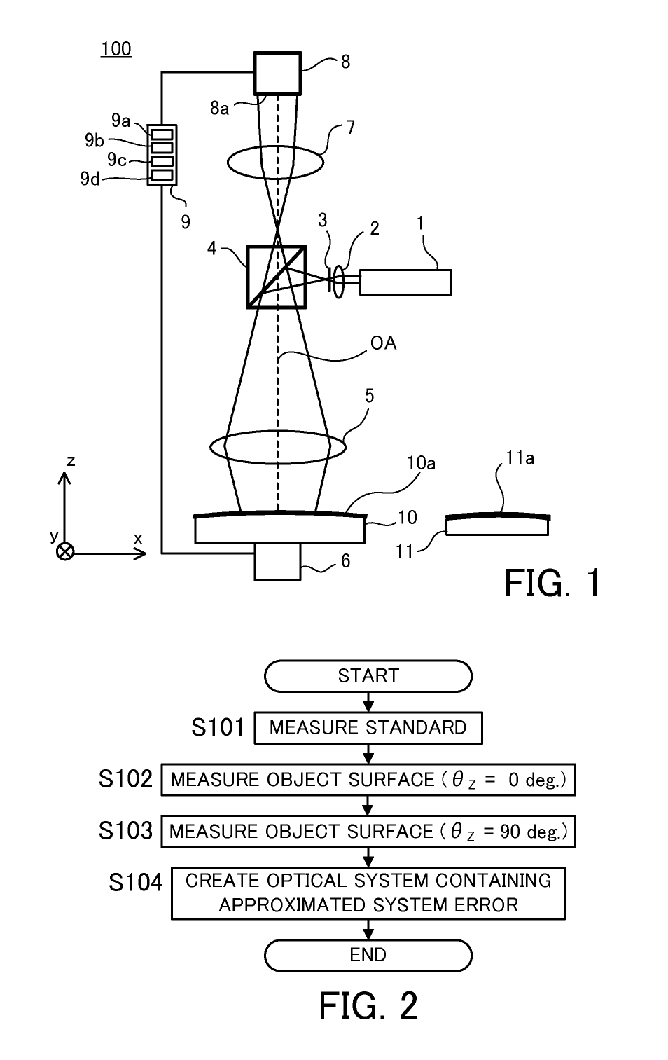

First of all, referring to FIG. 1, an aspherical surface measurement apparatus in Embodiment 1 of the present invention will be described. FIG. 1 is a schematic configuration diagram of an aspherical surface measurement apparatus 100 (object surface measurement apparatus) in this embodiment. Hereinafter, an xyz orthogonal coordinate system illustrated in FIG. 1 is set, and a position and a motion of each element will be described by using the xyz orthogonal coordinate system. Symbols ex, θy, and θz respectively denote rotations around x, y, and z axes as rotation axes, and a counterclockwise direction when viewed in a plus direction is defined as a plus.

In FIG. 1, reference numeral 1 denotes a light source, and reference numeral 2 denotes a condenser lens. Reference numeral 3 denotes a pinhole, and reference numeral 4 denotes a half mirror. Reference numeral 5 denotes a projection lens (illumination optical system). Reference numeral 10 denotes a lens (lens to be tested, or object) as an optical element to be tested, and its one surface is an object surface 10a (surface to be tested). Reference numeral 11 denotes a standard, and its one surface is a standard surface 11a as an aspherical surface. A surface shape of the standard surface 11a is previously measured by using another measurement device such as a stylus probe measurement device (i.e. the surface shape is known).

Reference numeral 6 denotes a driver (drive unit) that drives the lens 10 to be set to desired position and tilt (posture). The driver 6 rotates the lens 10 (object surface 10a) at the center of an optical axis OA (around the optical axis) in a calibration process described below. Reference numeral 7 denotes an imaging lens. In this embodiment, the imaging lens 7, along with the projection lens 5 and the half mirror 4, constitutes an imaging optical system. Reference numeral 8 denotes a sensor (light receiving sensor), which is a detection unit that detects a wavefront of light.

Reference numeral 9 denotes an analysis calculator (calculation unit) that includes a computer, and it calculates a shape of the object surface 10a based on an output signal of the sensor 8. The analysis calculator 9 includes a wavefront measurer 9a, a wavefront calculator 9b, a shape calculator 9c, and stitching calculator 9d. The wavefront measurer 9a measures a wavefront of light reflected by the object surface 10a (or the standard surface 11a) based on the output signal of the sensor 8. The wavefront calculator 9b calculates the measured wavefront. The shape calculator 9c calculates shapes of parts of the object surface 10a. The stitching calculator 9d stitches the shapes of the parts of the object surface 10a, and calculates an entire shape of the object surface 10a. The analysis calculator 9 functions also as a control unit that controls each portion such as the driver 6 of the aspherical surface measurement apparatus 100.

Light emitted from the light source 1 is condensed toward the pinhole 3 by the condenser lens 2. A spherical wave from the pinhole 3 is reflected by the half mirror 4 and then is converted into converged light by the projection lens 5. The converged light is reflected by the object surface 10a, and transmits through the projection lens 5, the half mirror 4, and the imaging lens 7, and then enters the sensor 8. The projection lens 5, the half mirror 4, and the imaging lens 7 constitute an optical system that guides light (detection light) reflected by the object surface 10a to the sensor 8.

The light source 1 is a laser light source or a laser diode that emits monochromatic laser light. The pinhole 3 is provided to generate a spherical wave having a small aberration. Therefore, instead of the pinhole 3, a single-mode fiber can be used. Each of the projection lens 5 and the imaging lens 7 is constituted by a plurality of lens elements, and a transmitted wavefront aberration caused by a surface shape error, an assembly error, homogeneity, and the like is for example not greater than 10 μm. A focal length, a radius of curvature, and a diameter of each of the projection lens 5 and the imaging lens 7 and a magnification of an optical system constituted by the combination of the projection lens 5 and the imaging lens 7 are determined based on a diameter (effective diameter) and a radius of curvature of the object surface 10a and a size of the light receiving portion of the sensor 8. The driver 6 is a five-axis stage, which includes an xyz stage, a rotation mechanism around a y axis, and a rotation mechanism around a z axis.

The lens 10 is disposed so that the object surface 10a approximately coincides with a sensor conjugate plane (i.e. plane conjugate to the sensor 8 via the imaging optical system) on the optical axis OA. Disposing the object surface 10a to coincide with the sensor conjugate plane, lights (rays) reflected by the object surface 10a do not overlap with each other on the sensor 8 (i.e. overlapping of the rays does not occur). Therefore, an angular distribution of the rays can be measured with high accuracy. In this embodiment, “the object surface 10a approximately coincides with a sensor conjugate plane” means a case where these are close to each other (substantially coincide with each other) to the extent that the overlapping of the rays does not occur, in addition to a case where these rigorously coincide with each other.

A design value of the object surface 10a is for example a rotationally-symmetric aspherical surface which is represented by the following expression (1).

$$S ( r ) = \frac{{cr}^{2}}{1 + \sqrt{1 - ( K + 1 ) {c}^{2} {r}^{2}}} + {A}_{4} {r}^{4} + {A}_{6} {r}^{6} + {A}_{8} {r}^{8} + {A}_{10} {r}^{10} + \qquad ( 1 )$$

In expression (1), symbol r denotes a distance from a center, symbol c denotes an inverse of a radius of curvature at the center, symbol K denotes a conic coefficient, and symbols A₄, A₆, . . . are aspherical coefficients.

The object surface 10a is illuminated by light (illumination light) as a converged spherical wave. When the object surface 10a is an aspherical surface, a reflection angle of the light depends on an aspherical amount (deviation from a spherical surface) and a shape error. When the aspherical amount is large, the reflection angle of the light is extremely different from an incident angle of light on the object surface 10a. In this case, an angle of light incident on the sensor 8 is large.

The sensor 8 includes a microlens array which is configured by disposing a number of micro condenser lenses in a matrix and an image pickup element such as a CCD, and it is typically called a Shack-Hartmann sensor. In the sensor 8, a ray (light beam) transmitting through the microlens array is condensed on the image pickup element for each micro condenser lens. The image pickup element photoelectrically converts an optical image formed by the ray from the micro condenser lens to output an electric signal. An angle Ψ of the ray incident on the image pickup element can be obtained by the analysis calculator 9 which detects a difference Δp between a position of a spot condensed by the micro condenser lens and a previously-calibrated position, for example a spot position obtained when parallel light is incident. The angle Ψ of the ray and the difference Δp of the spot positions satisfy the relation represented by the following expression (2), where f is a distance between the microlens array and the image pickup element.

$$Ψ = atan ( \frac{Δ p}{f} ) \qquad ( 2 )$$

The analysis calculator 9 performs the processing described above for all the micro condenser lenses, and accordingly it can measure an angular distribution of the rays incident on a sensor surface 8a (microlens array surface) by using outputs from the sensor 8. The sensor 8 only has to measure the wavefront or the angular distribution of the ray, and therefore it is not limited to the Shack-Hartmann sensor. For example, a Talbot interferometer or a shearing interferometer that includes a Hartmann plate or a diffractive grating and an image pickup element can also be used as the sensor 8.

Next, a method of performing a stitching measurement by reducing a rotationally-asymmetric system error of a measurement system (optical system or aspherical surface measurement apparatus 100) based on a measured value of a known standard surface 11a, a measured value of the object surface 10a, and a measured value obtained when the object surface 10a is rotated by 90 degrees will be described. The rotationally-asymmetric system error of the measurement system means a measurement error which occurs due to a surface shape error of the projection lens 5 or the imaging lens 7, an alignment error, homogeneity, an error of the sensor 8, or the like. The aspherical surface measurement method in this embodiment includes two steps of a calibration process and a stitching measurement process.

Next, referring to FIG. 2, a calibration process in this embodiment will be described. FIG. 2 is a flowchart of illustrating the calibration process in the aspherical surface measurement method. Each step in FIG. 2 is performed mainly by the sensor 8, the analysis calculator 9, and the driver 6 in the aspherical surface measurement apparatus 100.

First of all, at step S101, a standard 11 is disposed so that the standard surface 11a and the sensor conjugate plane coincide with each other on the optical axis, and then a reflected wavefront of the standard surface 11a is measured by using the sensor 8 (standard measurement). A wavefront obtained by the sensor 8 in this time is denoted by Wₛ. It is preferred that optical paths of reflected lights transmitting through the optical system for the standard surface 11a and the object surface 10a are close to each other. Therefore, the standard surface 11a is a rotationally-symmetric aspherical surface which has a design value close to a design value of a peripheral partial region of the object surface 10a. Its effective diameter has a size which can be measured at once by the aspherical surface measurement apparatus 100.

Subsequently, at step S102, the lens 10 (object) is disposed so that the optical axis OA of the aspherical surface measurement apparatus 100 and a center axis of the object surface 10a coincide with each other, and then the reflected wavefront of the object surface 10a is measured by using the sensor 8 (object surface measurement (θ_{z}=0 degree)). A wavefront obtained by the sensor 8 in this time is denoted by W₀. Subsequently, at step S103, the lens 10 is rotated by 90 degrees around the center axis of the object surface 10a as a rotation axis, and then its reflected wavefront is measured by using the sensor 8 (object surface measurement (θ_{z}=90 degree)). A wavefront obtained by the sensor 8 in this time is denoted by W₉₀. Subsequently, at step S104, the analysis calculator 9 approximates the system error based on the wavefronts Wₛ, W₀, and W₉₀ (measured wavefronts) measured at steps S101 to S103, and it creates an optical system reflecting the approximated system error. Hereinafter, a method of creating the optical system will be described in detail.

First of all, the analysis calculator 9 performs a ray tracing calculation from the pinhole 3 to the sensor surface 8a by using optical software based on the design value of the optical system such as the projection lens 5 and the imaging lens 7, the design value of the standard surface 11a, and surface data of the standard surface 11a previously measured by another apparatus. Then, the analysis calculator 9 calculates a wavefront W_{cs} (calculated wavefront) on the sensor surface 8a based on a result of the ray tracing calculation. When performing the ray tracing calculation, the analysis calculator 9 may measure the aberration of the lens constituting the optical system, the surface shape, the homogeneity, and the like, and then it may reflect the measured value to perform the calculation.

Subsequently, the analysis calculator 9 calculates an error component wavefront Wₛ_{_{—}}_{sys} of the optical system based on a difference between the wavefront Wₛ (measured wavefront) and the wavefront W₀ₛ (calculated wavefront). Then, the analysis calculator 9 fits the error component wavefront Wₛ_{_{—}}_{sys} by using the Fringe Zernike polynomial to calculate a coefficient sᵢ. Thus, the error component wavefront Wₛ_{_{—}}_{sys} is represented by the following expression (3).

$${W}_{s \_ sys} = {W}_{s} - {W}_{cs} = {\sum }_{i = 5} {s}_{i} {Z}_{i} \qquad ( 3 )$$

The detail of the Fringe Zernike polynomial is described in “ROBERT R. SHANNON and JAMES C. WYANT, ‘APPLIED OPTICS and OPTICAL ENGINEERING’, San Diego USA, ACADEMIC PRESS, Inc., 1992, Volume XI, p. 28-34”, and therefore a specific expression of its function is omitted. In this embodiment, the i-th term of the Zernike polynomial is denoted by Zᵢ. First to fourth terms of the Zernike polynomial are components that change depending on the alignment of the standard 11 and that are not regarded as the system error, and accordingly symbol i means an integer not less than five.

The wavefront W₀ (measured wavefront) contains a wavefront aberration W_{δz0} that occurs due to a shape error δz of the object surface 10a, a wavefront aberration W_{sys} that occurs due to the system error, and a rotationally-symmetric wavefront W_{ideal} that is calculated by using the design values of the optical system and the object surface 10a. The wavefront W₀ is represented by the following expression (4).

W₀=W_{δz0}W_{sys}+W_{ideal} (4)

Similarly, the wavefront W₉₀ (measured wavefront) contains a wavefront aberration W_{δz90} that occurs due to the shape error δz of the object surface 10a rotated by 90 degrees, the wavefront aberration W_{sys}, and the wavefront W_{ideal}. The wavefront W₉₀ is represented by the following expression (5).

W₉₀=W_{δz90}+W_{sys}+W_{ideal} (5)

Even when the object surface 10a is rotated, change amounts of the wavefront aberration W_{sys} and the wavefront W_{ideal} are small and therefore they can be regarded to be identical to values in expression (4). When the wavefront W₉₀ is rotated by −90 degrees to calculate a difference from the wavefront W₀ based on expressions (4) and (5), the difference between the wavefront aberration W_{sys} rotated by −90 degrees and the wavefront aberration W_{sys} can be obtained. The wavefront aberration W_{sys} other than rotationally symmetric components and 4n rotationally symmetric components can be obtained based on this difference. In this case, n is a positive integer.

The analysis calculator 9 obtains a coefficient tᵢ by fitting the wavefront aberration W_{sys} as Wₜ_{_{—}}_{sys} by using the Zernike polynomial. The wavefront aberration Wₜ_{_{—}}_{sys} is represented by the following expression (6).

$${W}_{t \_ sys} = {\sum }_{i = 5} {t}_{i} {Z}_{i} \qquad ( 6 )$$

An angle to rotate the lens 10 is not limited to 90 degrees, and it can be rotated at an arbitrary angle. Preferably, the angle to rotate the lens 10 is set to be within a range of 45 to 135 degrees. A plurality of measurements can be performed while the angle changes, i.e. the measurements can be performed at three or more angles different from each other including 0 and 90 degrees and an arbitrary angle other than 0 and 90 degrees. This is preferable since a wavefront aberration other than the rotationally symmetric components can be obtained.

Next, parts of parameters of the optical system, for example a lens surface and a refractive index distribution are changed by using the error component wavefront Wₛ_{_{—}}_{sys} and the wavefront aberration Wₜ_{_{—}}_{sys}. Hereinafter, for example, two lens surfaces P and Q are specified as parameters to be changed, and the shape errors δzₚ and δz_{q} represented by the following expressions (7-1) and (7-2) are added. The lens surfaces P and Q are surfaces having high sensitivities of the projection lens 5 and the imaging lens 7, respectively. The surface having high sensitivity means a surface having a large change amount of a wavefront on the sensor 8 when a unit amount of an error is contained.

$$\begin{matrix}δ {z}_{p} = {\sum }_{i = 5}^{ } {f}_{i} {Z}_{i} & ( 7 \text{-} 1 ) \\ δ {z}_{q} = {\sum }_{i = 5}^{ } {g}_{i} {Z}_{i} & ( 7 \text{-} 2 )\end{matrix}$$

In expressions (7-1) and (7-2), symbol i denotes an integer not less than five, and symbols fᵢ and gᵢ are coefficients of the Fringe Zernike polynomial Zᵢ.

When obtaining the coefficients fᵢ and gᵢ, first, the analysis calculator 9 adds surface errors Zⱼ (j is an integer not less than five) by the unit amount to the lens surfaces P and Q and calculates change amounts of a wavefront of the light reflected by the standard surface 11a on the sensor surface 8a. Change amounts ΔW_{Psj} and ΔW_{Qsj} of the wavefront are represented by the following expressions (8-1) and (8-2), respectively.

$$\begin{matrix}Δ {W}_{Psj} = {\sum }_{i = 5}^{ } {p}_{sij} {Z}_{i} & ( 8 \text{-} 1 ) \\ Δ {W}_{Qsj} = {\sum }_{i = 5} {q}_{sij} {Z}_{i} & ( 8 \text{-} 2 )\end{matrix}$$

In expressions (8-1) and (8-2), symbols pₛᵢⱼ and qₛᵢⱼ are coefficients of the Fringe Zernike polynomial Zᵢ.

Then, the analysis calculator 9 similarly adds the surface errors Zⱼ by the unit amount to the lens surfaces P and Q and calculates change amounts of a wavefront of the light reflected by the object surface (design value) on the sensor surface 8a. Change amounts ΔW_{Ptj} and ΔW_{Qtj} of the wavefront are represented by the following expressions (9-1) and (9-2), respectively.

$$\begin{matrix}Δ {W}_{Ptj} = {\sum }_{i = 5}^{ } {p}_{tij} {Z}_{i} & ( 9 \text{-} 1 ) \\ Δ {W}_{Qtj} = {\sum }_{i = 5}^{ } {q}_{tij} {Z}_{i} & ( 9 \text{-} 2 )\end{matrix}$$

In expressions (9-1) and (9-2), symbol i is an integer not less than five, and symbols pₜᵢⱼ and qₜᵢⱼ are coefficients of the Fringe Zernike polynomial Zᵢ.

Obtaining the coefficients f and g of the surface errors of the lens surfaces P and Q so that the wavefronts of the coefficients in expressions (3) and (6) and the calculated wavefronts in which the errors are added to the lens surfaces P and Q coincide with each other, the optical system reflecting the system error can be reproduced on the computer. The coefficients f and g can be obtained by solving the following expression (10).

$$[ \begin{matrix}{s}_{5} \\ {s}_{6} \\ ⋮ \\ {t}_{5} \\ {t}_{6} \\ ⋮\end{matrix} ] = ( \begin{matrix}{p}_{s 55} & {p}_{s 56} & … & {q}_{s 55} & {q}_{s 56} & … \\ {p}_{s 65} & {p}_{s 66} & … & {q}_{s 65} & {q}_{s 66} & … \\ ⋮ & ⋮ & ⋱ & ⋮ & ⋮ & ⋱ \\ {p}_{t 55} & {p}_{t 56} & … & {q}_{t 55} & {q}_{t 56} & … \\ {p}_{t 65} & {p}_{t 66} & … & {q}_{t 65} & {q}_{t 66} & … \\ ⋮ & ⋮ & ⋱ & ⋮ & ⋮ & ⋱\end{matrix} ) [ \begin{matrix}{f}_{5} \\ {f}_{6} \\ ⋮ \\ {g}_{5} \\ {g}_{6} \\ ⋮\end{matrix} ] \qquad ( 10 )$$

Expression (10) can be solved by a least-squares method, a SVD (Singular Value Decomposition) method, or the like. According to the obtained coefficients f and g, the shape errors δzₚ and δz_{q} represented by expressions (7-1) and (7-2) are respectively added to the lens surfaces P and Q. The optical system obtained by adding the shape errors (i.e. optical system created at step S104) is called a simulated optical system. The simulated optical system is used in the ray tracing calculation to be performed at step S115 described below.

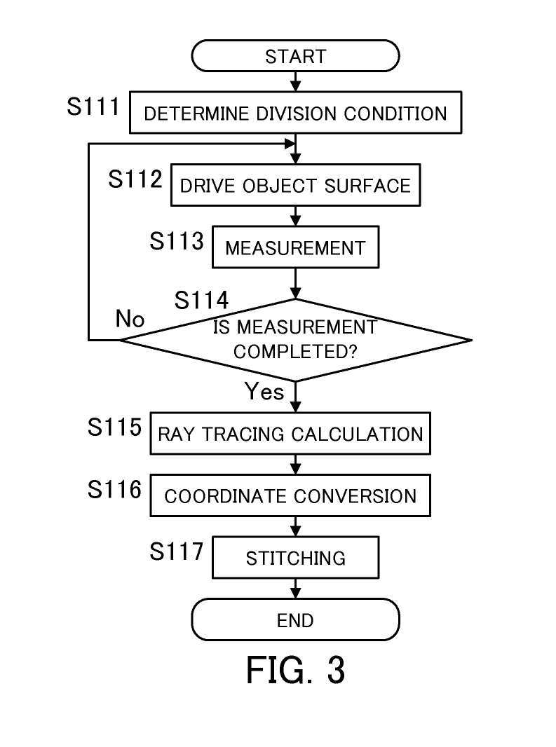

Next, referring to FIG. 3, a stitching measurement process will be described. FIG. 3 is a flowchart of illustrating the stitching measurement process of the aspherical surface measurement method in this embodiment. Each step in FIG. 3 is performed mainly by the sensor 8, the analysis calculator 9, and the driver 6 in the aspherical surface measurement apparatus 100.

First, at step S111, the analysis calculator 9 determines a division condition. The division condition is determined depending on a diameter or a radius of curvature of the object surface 10a, a diameter of a light beam illuminated onto the object surface 10a, and a size of an overlapping region of partial measurement regions. The driver 6 drives the lens 10 according to the division condition determined by the analysis calculator 9. When the division condition is determined, drive amounts Xv and Zv in X and Z directions, a drive amount θyv of θy tilt, and a drive amount θzv of θz rotation are determined based on the design values. First, the drive of the lens 10 starts from a state in which the center of the object surface 10a coincides with the optical axis OA of the optical system in the aspherical surface measurement apparatus 100. After the drive of the lens 10 starts, the driver 6 moves the lens 10 in the X direction by the drive amount Xv, and it moves the lens 10 in the Z direction by the drive amount Zv so that a difference between a curvature of the sensor conjugate plane or the illumination light and a curvature of the partial measurement region of the object surface 10a decreases. In the former case, Zv=S(Xv) is obtained by using expression (1).

Next, the tilt is given by δyv around the Y axis so that a shape difference δZ between the spherical surface where the reflected light becomes a plane wave on the sensor 8 and the object surface 10a of the partial measurement region or a difference δdZ between their differential shapes is minimized. When the shape difference δZ and the difference δdZ is greater than a predetermined value, the diameter of the partial measurement region may be decreased and the number N of measurements (N is an integer) may be increased.

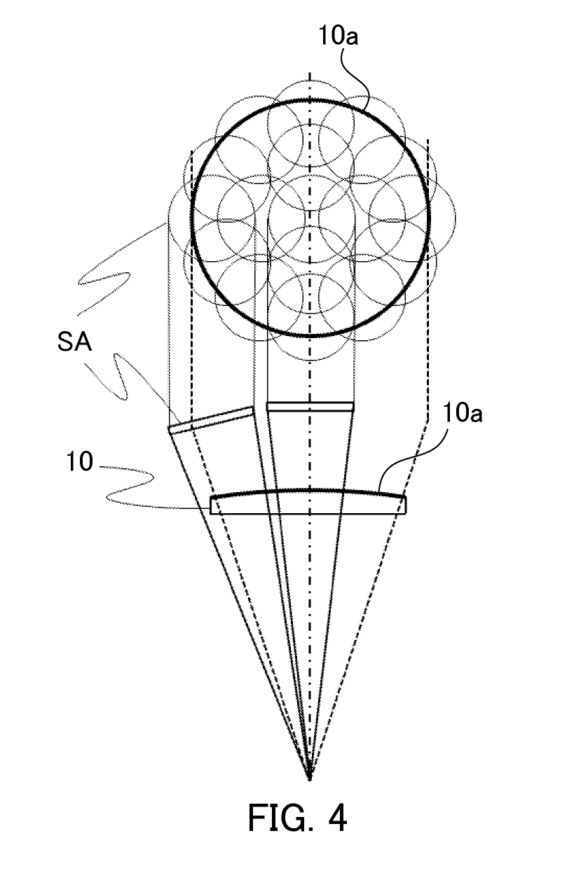

Finally, the driver 6 rotates the object surface 10a around its center by θzv. A divisional example determined as described above is illustrated in FIG. 4. FIG. 4 is a schematic diagram of illustrating the partial measurement regions when division measurements are performed for the object surface 10a in this embodiment. In FIG. 4, a region inside a circle depicted by a heavy solid line represents the object surface 10a. Each of regions inside circles depicted by thin solid lines represents a partial measurement region SA. In FIG. 4, the number of drives in the X direction is two, and the number N of measurements is 17. When a partial measurement region at the center is a first stage, a partial measurement region after the drive in the X direction once is a second stage, and a partial measurement region after the drives in the X direction twice is a third stage, the angle θzv in the second stage is 90 degrees, and the angle θzv in the third stage is 30 degrees. The numbers of measurements for the first, second, and third stages are 1, 4, and 12, respectively. The overlapping region between adjacent partial measurement regions increases with the decrease of Xv and θzv. Each partial measurement region is determined to have an overlapping region to cover an entire region of the object surface 10a.

Subsequently, at step S112, the driver 6 drives the lens 10 according to the drive depending on the division condition determined at step S111 (object surface drive). Then, at step S113, a wavefront Wₐᵢ of light reflected by part (partial measurement region) of the object surface 10a is measured by using the sensor 8. In this embodiment, symbol i denotes a positive integer which represents the number of the partial measurement regions, and for example i=1 when the measurement is performed for the first stage.

Subsequently, at step S114, the analysis calculator 9 determines whether the measurement is completed. In this case, the analysis calculator 9 determines whether or not the measurement of the object surface 10a is finished, i.e. whether or not the measurements of the partial measurement regions N times have been performed. When the partial measurement is not completed, one is added to the integer i and then the flow returns to step S112. On the other hand, when the partial measurement is completed, the flow proceeds to step S115.

At step S115, the analysis calculator 9 performs the ray tracing by using the sensor 8 based on the wavefront Wₐ measured at step S113 and the simulated optical system to calculate shapes of the partial measurement regions of the object surface 10a (ray tracing calculation). Specifically, first, the ray tracing calculation is performed by using the simulated optical system from the sensor surface 8a to the object surface 10a by optical software based on a measured position (x,y) of the ray on the sensor surface 8a and a ray inclination (φx,φy) corresponding to a differential of the measured wavefront Wₐ. Then, the analysis calculator 9 calculates a position (xₛ,yₛ) and an angle (φxₛ,φyₛ) of the ray when the object surface 10a and the ray intersects with each other.

Next, the analysis calculator 9 subtracts a ray reflection angle of the object surface 10a of a design value obtained by calculation from the angle (φxₛ,φyₛ) of the ray and a two-dimensional integral is performed on the slope (inclination) to calculate the shape errors δzₛ(xₛ,yₛ) of the partial measurement regions of the object surface 10a. The shape zₛ of the partial measurement region is a value obtained by adding the shape error δzₛ to the design value of the object surface 10a. Performing the ray tracing calculation by using the simulated optical system, the error of the optical system is calibrated.

Subsequently, at step S116, the analysis calculator 9 converts a shape (xₛ,yₛ,zₛ) of the partial measurement region of the object surface 10a into a coordinate (global coordinate: x, y, and z) representing the object surface 10a (coordinate conversion). The coordinate conversion is performed based on calculation represented by the following expression (11).

$$[ \begin{matrix}{x}_{u} \\ {y}_{u} \\ {z}_{u}\end{matrix} ] = Rotz ( - {θ}_{zv} ) Shift ( - {X}_{v} , 0 , - {Z}_{v} ) Roty ( - {θ}_{yv} ) [ \begin{matrix}{x}_{t} \\ {y}_{t} \\ {z}_{t}\end{matrix} ] = ( \begin{matrix}cos ( {θ}_{zv} ) & sin ( {θ}_{zv} ) & 0 \\ - sin ( {θ}_{zv} ) & cos ( {θ}_{zv} ) & 0 \\ 0 & 0 & 1\end{matrix} ) \{ ( \begin{matrix}cos ( {θ}_{yv} ) & 0 & sin ( {θ}_{yv} ) \\ 0 & 1 & 0 \\ - sin ( {θ}_{yv} ) & 0 & cos ( {θ}_{yv} )\end{matrix} ) [ \begin{matrix}{x}_{t} \\ {y}_{t} \\ {z}_{t}\end{matrix} ] - ( \begin{matrix}{X}_{v} \\ 0 \\ {Z}_{v}\end{matrix} ) \} \qquad ( 11 )$$

A coordinate (xᵤ,yᵤ) obtained by expression (11) is not arrayed in equal intervals, and therefore the difference calculation between the partial measurement region data cannot be performed at step S117. Accordingly, the analysis calculator 9 performs interpolation so that the coordinate (xᵤ,yᵤ) is changed to a coordinate (x,y) arrayed in an equal-interval lattice and then calculates z at the coordinate (x,y).

Subsequently, at step S117, the analysis calculator 9 estimates an alignment error of the lens 10 obtained when performing the partial measurement based on the shape difference of the overlapping region between the partial measurement regions. Specifically, the shape difference caused by the alignment error when the i-th partial measurement region is measured is denoted by fᵢⱼ where i is an integer from 1 to N to identify the data of the partial measurement regions. Symbol j denotes a type of the alignment error, and j=1, 2, 3, 4, and 5 represents Z shift (piston), X shift, Y shift, ex tilt, and θy tilt, respectively. Symbol fᵢⱼ is obtained by calculating a difference after driving the object surface 10a by X_{q}, Z_{q}, θy_{q}, and θz_{q} on the computer by using the design value of the object surface 10a and then changing the posture (five axes) by unit amounts to perform the coordinate conversions at step S116 for the values before and after the change.

A shape z′ᵢ of the i-th partial measurement region determined at step S116 is obtained by adding the alignment error component fᵢⱼ to the shape zᵢ of the object surface 10a. Accordingly, the shape z′ᵢ is represented by the following expression (12).

$${z}_{i}^{′} ( x , y ) = {z}_{i} ( x , y ) + {\sum }_{j = 1}^{5} {a}_{ij} {f}_{ij} ( x , y ) \qquad ( 12 )$$

The difference between partial measurement shape data for the overlapping region is caused by the alignment error of the lens 10. Therefore, a shape difference Δ of the overlapping region of the partial measurement regions, which is represented by the following expression (13), only has to be minimized and obtain a coefficient aᵢⱼ in this time.

$$Δ = {\sum }_{n = 1}^{N} {\sum }_{m = 1}^{N} {\sum }_{n ⋂ m}^{ } {\{ {z}_{n}^{′} ( x , y ) - {z}_{m}^{′} ( x , y ) \}}^{2} \qquad ( 13 )$$

In expression (13), each of n and m is an integer within a range of 1 to N, and symbol n∩m represents an overlapping region of the n-th and m-th partial measurement regions. The condition to minimize the shape difference Δ according to the coefficient aᵢⱼ is that a value determined by differentiating the shape difference Δ with respect to the coefficient aᵢⱼ is zero. In this case, the following expression (14) is satisfied.

$$\frac{\partial Δ}{\partial {a}_{ij}} = 0 \qquad ( 14 )$$

Thus, solving the system of equations represented by expression (14) for all of i and j satisfying 1≦i≦N and 1≦j≦5 the coefficient aᵢⱼ is obtained. Subtracting the second term on the right side of expression (12) from the shape z′ᵢ after the alignment error (aᵢ) is obtained, the shape Zᵢ of the partial measurement region of the object surface 10a can be obtained. Finally, the analysis calculator 9 can obtain an entire shape of the object surface 10a by averaging the shapes of the partial measurement regions overlapping with each other (stitching).

As described above, the aspherical surface measurement method in this embodiment first measures a first wavefront (wavefront Wₛ) of light from the standard surface 11a having a known shape, i.e. known aspherical shape (step S101), and then measures a second wavefront (wavefront W₀) of light from the object surface 10a having an aspherical shape (step S102). Subsequently, the method rotates the object surface 10a around an optical axis and then measures a third wavefront (wavefront W₉₀) of light from the object surface 10a (step S103). These measurements are performed by the sensor 8 and the analysis calculator 9 of the aspherical surface measurement apparatus 100. Subsequently, the method calculates error information of the optical system (such as the projection lens 5 and the imaging lens 7) based on the first wavefront, the second wavefront, and the third wavefront (step S104). Then, the method calculates shapes of a plurality of partial regions of the object surface 10a by using a design value of the optical system corrected based on the error information of the optical system and by using a plurality of measured wavefronts of lights from the partial regions measured after the object surface 10a is driven (steps S115 and S116). Finally, the method stitches (i.e. performs stitching of) the shapes of the partial regions of the object surface 10a to calculate an entire shape of the object surface 10a (step S117). These calculation is performed by the analysis calculator 9 of the aspherical surface measurement apparatus 100.

Preferably, the step (step S103) of rotating the object surface 10a for measuring the third wavefront includes rotating the object surface 10a disposed at the step (step S102) of measuring the second wavefront within a range of 45 to 135 degrees around the optical axis. More preferably, the step of rotating the object surface 10a includes rotating the object surface 10a disposed at the step of measuring the second wavefront by 90 degrees around the optical axis.

Preferably, at the step (step S104) of calculating the error information of the optical system, the analysis calculator 9 performs the ray tracing calculation by using the design value of the optical system, the design value of the standard surface, and the surface data of the standard surface. Then, the analysis calculator 9 calculates the error information of the optical system based on the first wavefront, the second wavefront, the third wavefront, and the fourth wavefront (W_{cs}) calculated by the ray tracing calculation. More preferably, the error information of the optical system contains error information of a rotationally asymmetric component of the optical system.

Preferably, the aspherical surface measurement method in this embodiment, at the step of calculating the shapes of the partial regions of the object surface, performs drives including parallel movements, rotations, or tilts of the object surface 10a a plurality of times, and measures, as the measured wavefronts, wavefronts of lights from the partial regions of the object surface 10a after each of the drives. Preferably, the aspherical surface measurement method in this embodiment determines the division condition of the object surface 10a (step S111), and drives the object surface 10a based on the division condition (step S112). Subsequently, the method measures the shapes of the partial regions of the object surface 10a based on the wavefronts (measured wavefronts) of the lights from the object surface 10a (step S113). Then, the method repeats the step (step S112) of driving the object surface 10a and the step (step S113) of measuring the shapes of the partial regions of the object surface 10a to acquire the measured wavefronts related to the partial regions which include regions overlapping with each other (steps S112 and S113). Each of these steps is performed by the analysis calculator 9 (calculation unit and control unit).

Preferably, the step (step S113) of measuring the shapes of part (i.e. partial regions) of the object surface includes illuminating, as illumination light that is a spherical wave, light from the light source 1 onto the object surface 10a, and guiding, as detection light, reflected light or transmitted light from the object surface 10a to the sensor 8 by using the imaging optical system. Then, using the sensor 8, the detection light guided by the imaging optical system is detected.

According to the aspherical surface measurement method in this embodiment, an aspherical shape of an object having a large diameter can be measured with high accuracy in a noncontact manner even when a measurement system contains a rotationally asymmetric error.

### Embodiment 2

Next, an aspherical surface measurement method in Embodiment 2 of the present invention will be described. The aspherical surface measurement method in Embodiment 1 is a method of calibrating a rotationally-asymmetric system error, while the aspherical surface measurement method in this embodiment is a method of further calibrating a rotationally-symmetric system error. The rotationally-symmetric system error is a measurement error which is caused by an error of an interval between lens surfaces constituting an optical system, an error of curvature of the lens surface, and the like. A basic configuration of an aspherical surface measurement apparatus in this embodiment is the same as that of the aspherical surface measurement apparatus 100 in Embodiment 1 described with reference to FIG. 1, and the apparatus of this embodiment is different from the aspherical surface measurement apparatus 100 of Embodiment 1 in that the rotationally-symmetric system error is estimated based on a difference of shapes of measurement regions overlapping with each other. Specifically, step S117 in FIG. 3 is different from Embodiment 1, and the method is changed as described below.

The shape z′ᵢ of the i-th partial measurement region determined at step S116 is obtained by adding an alignment error component fᵢⱼ and a rotationally-symmetric system error component gᵢₖ to the shape zᵢ of the object surface 10a. Accordingly, the shape z′ᵢ is represented by the following expression (15).

$${z}_{i}^{′} ( x , y ) = {z}_{i} ( x , y ) + {\sum }_{j = 1}^{5} {a}_{ij} {f}_{ij} ( x , y ) + {\sum }_{k = 1}^{{N}_{n}} {b}_{ik} {g}_{ik} ( x , y ) \qquad ( 15 )$$

In expression (15), Nₙ is the number of functions gᵢₖ when the integer i is fixed, and k is an integer not less than 1.

A method of calculating the function gᵢₖ (basis function) which represents the rotationally-symmetric system error is as follows. First, a rotationally-symmetric shape error by a unit amount after the object surface 10a is driven by drive amounts Xv, Zv, θyv, and θzq on the computer, i.e. the Fringe Zernike polynomial Z(k+1)², is added to the design value of the object surface 10a as represented by expression (1). Next, the coordinate conversion is performed at step S116 for the values before and after the addition of the shape error, and then a difference between the two values is calculated to obtain the basis function. For the measurement of the stitching, since positions where lights reflected by the object surface 10a transmit through the optical system are substantially the same if stages (i.e. drive amounts Xv, Zv, and θyv) are the same, the system error can also be considered to be the same. Accordingly, in the example illustrated in FIG. 4, b₂ₖ=b₃ₖ=b₄ₖ=b₅ₖ is satisfied for the second stage since i is 2 to 5. For the third stage, b₆ₖ=b₇ₖ=b₈ₖ=b₉ₖ=b₁₀ₖ=b₁₁ₖ=b₁₂ₖ=b₁₃ₖ=b₁₄ₖ=b₁₅ₖ=b₁₆ₖ=b₁₇ₖ is satisfied since i is 6 to 17.

The difference between the partial measurement shape data for the overlapping region is caused by the alignment error and the rotationally-symmetric system error of the lens 10. Therefore, a shape difference Δ of the overlapping region of the partial measurement regions, which is represented by the following expression (16), only has to be minimized and obtain coefficients and bᵢₖ in this time.

$$Δ = {\sum }_{n = 1}^{N} {\sum }_{m = 1}^{N} {\sum }_{n ⋂ m}^{ } {\{ {S}_{n}^{′} ( x , y ) - {S}_{m}^{′} ( x , y ) \}}^{2} \qquad ( 16 )$$

In expression (16), each of n and m is an integer within a range of 1 to N, and symbol n∩m represents an overlapping region of the n-th and m-th partial measurement regions. The condition to minimize the shape difference Δ according to the coefficients and bᵢₖ is that a value determined by differentiating the shape difference Δ with respect to the coefficients aᵢⱼ and bᵢₖ is zero. In this case, the following expression (17) is satisfied.

$$\frac{\partial Δ}{\partial {a}_{ij}} = 0 , \frac{\partial Δ}{\partial {b}_{ik}} = 0 \qquad ( 17 )$$

Accordingly, solving the system of equations represented by expression (17) for all of i, j, and k satisfying and the coefficients aᵢⱼ and bᵢₖ are obtained. In this embodiment, some of values of bᵢₖ may be identical, and in this case, the system of equations can be solved on condition that these are identical. Subtracting the second term and the third term on the right side of expression (15) from the shape z′ᵢ after the alignment error (aᵢⱼ) and the system error (bᵢₖ) are obtained, the shape Zᵢ of the partial measurement region of the object surface 10a can be obtained. Finally, the analysis calculator 9 can obtain an entire shape of the object surface 10a by averaging the shapes of the partial measurement regions overlapping with each other (stitching).

As described above, in this embodiment, the error information of the optical system contains error information of the rotationally symmetric component of the optical system. According to the aspherical surface measurement method in this embodiment, a system error (rotationally-symmetric system error) included in a measurement system can be reduced and an aspherical shape of an object having a large diameter can be measured with high accuracy.

### Embodiment 3

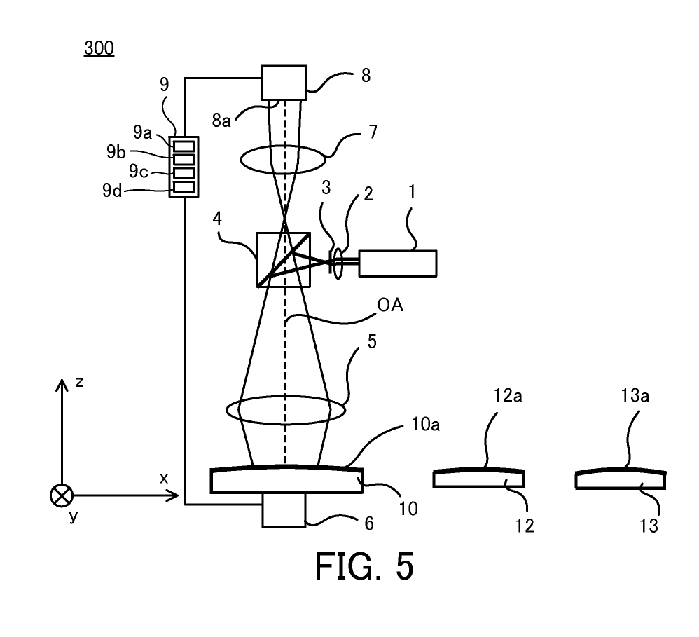

Next, referring to FIG. 5, an aspherical surface measurement apparatus in Embodiment 3 of this embodiment will be described. FIG. 5 is a schematic configuration diagram of an aspherical surface measurement apparatus 300 in this embodiment.

This embodiment is different from each of Embodiments 1 and 2 in the calibration process in the aspherical surface measurement method. The calibration process in this embodiment is performed by using two standards 12 and 13 having aspherical standard surfaces 12a and 13a respectively, which are previously measured by using another apparatus. In this embodiment, for example, the standard surface 12a has an aspherical design value so that an optical path where reflected light passes through the optical system when measuring a first stage of the object surface 10a illustrated in FIG. 4 and an optical path where reflected light of the standard surface 12a passes through the optical system are close to each other. The standard surface 13a has an aspherical design value so that an optical path where reflected light passes through the optical system when measuring a third stage of the optical surface 10a illustrated in FIG. 4 and an optical path where reflected light of the standard surface 13a passes through the optical system are close to each other. A measurement system of the aspherical surface measurement apparatus 300 is the same as that of the aspherical surface measurement apparatus 100.

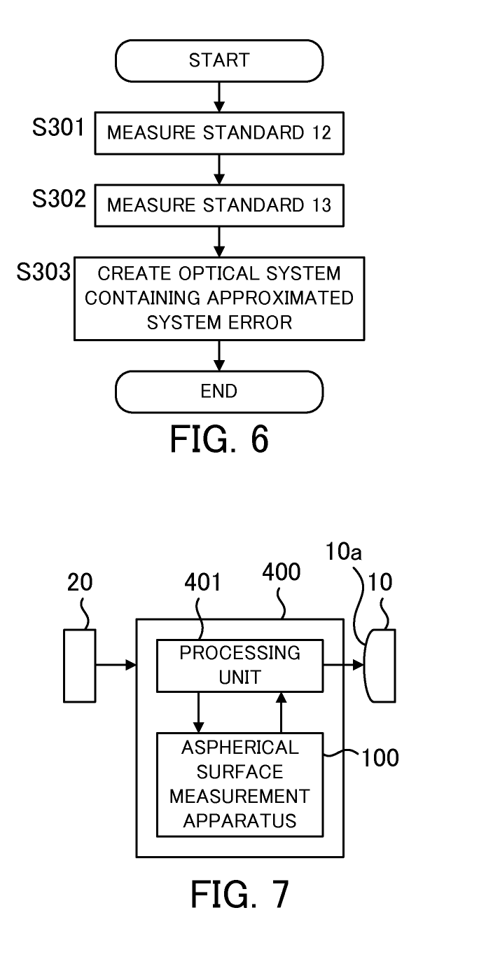

Subsequently, referring to FIG. 6, a calibration process in this embodiment will be described. FIG. 6 is a flowchart of illustrating the calibration process in the aspherical surface measurement method. Each step in FIG. 6 is performed mainly by the sensor 8, the analysis calculator 9, and the driver 6 in the aspherical surface measurement apparatus 300.

First, at step S301, the standard 12 is disposed so that the standard surface 12a and the sensor conjugate plane coincide with each other on the optical axis, and then a reflected wavefront of the standard surface 12a is measured by using the sensor 8 (measurement of the standard 12). A wavefront obtained by the sensor 8 in this time is denoted by W₁. Subsequently, at step S302, the standard 13 is disposed so that the standard surface 13a and the sensor conjugate plane coincide with each other on the optical axis, and then a reflected wavefront of the standard surface 13a is measured by using the sensor 8 (measurement of the standard 13). A wavefront obtained by the sensor 8 in this time is denoted by W₂.

Subsequently, at step S303, similarly to step S104 in FIG. 2, the analysis calculator 9 approximates the system error based on the wavefronts W₁ and W₂ (measured wavefronts) measured at steps S301 and S302, and it creates an optical system reflecting the approximated system error. In other words, the analysis calculator 9 performs a ray tracing calculation from the pinhole 3 to the sensor surface 8a by using optical software based on the design value of the optical system, the design value of the standard surface 12a, and surface data of the standard surface 12a previously measured by another apparatus. Then, the analysis calculator 9 calculates a wavefront W_{c1} on the sensor surface 8a based on a result of the ray tracing calculation.

Subsequently, the analysis calculator 9 calculates an error component wavefront W_{sys1} of the optical system based on a difference between the wavefront W₁ (measured wavefront) and the wavefront W_{c1} (calculated wavefront). Then, the analysis calculator 9 fits the error component wavefront W_{sys1} by using the Fringe Zernike polynomial to calculate its coefficient sᵢ. Thus, the error component wavefront W_{sys1} is represented by the following expression (18).

$${W}_{sys 1} = {W}_{1} - {W}_{c 1} = {\sum }_{i = 5} {s}_{i} {Z}_{i} \qquad ( 18 )$$

In expression (18), symbol i denotes an integer not less than five.

The analysis calculator 9 performs the similar calculation for the standard 13. In other words, the analysis calculator 9 performs a ray tracing calculation from the pinhole 3 to the sensor surface 8a by using optical software based on the design value of the optical system, the design value of the standard surface 13a, and surface data of the standard surface 13a previously measured by another apparatus. Then, the analysis calculator 9 calculates a wavefront W_{c2} on the sensor surface 8a based on a result of the ray tracing calculation.

Subsequently, the analysis calculator 9 calculates an error component wavefront W_{sys2} of the optical system based on a difference between the wavefront W₂ (measured wavefront) and the wavefront W_{c2} (calculated wavefront). Then, the analysis calculator 9 fits the error component wavefront W_{sys2} by using the Fringe Zernike polynomial to calculate its coefficient tᵢ. Thus, the error component wavefront W_{sys2} is represented by the following expression (19).

$${W}_{sys 2} = {W}_{2} - {W}_{c 2} = {\sum }_{i = 5}^{ } {t}_{i} {Z}_{i} \qquad ( 19 )$$

In expression (19), symbol i denotes an integer not less than five.

Subsequently, the analysis calculator 9 obtains the coefficients sᵢ and tᵢ by the same calculation as that at step S104 in FIG. 2, and it measures a surface shape of the object surface 10a through the same process as the stitching measurement process in Embodiment 1.

As described above, the aspherical surface measuring method first measures a first wavefront (wavefront W₁) of light from a first standard surface (standard surface 12a) having a first known shape, i.e. first known aspherical shape (step S301). Furthermore, the method measures a second wavefront (wavefront W₂) of light from a second standard surface (standard surface 13a) having a second known shape, i.e. second known aspherical shape (step S302). These measurements are performed by the sensor 8 and the analysis calculator 9 in the aspherical surface measurement apparatus 300. Subsequently, the method calculates error information of the optical system based on the first wavefront and the second wavefront (step S303). Then, the method calculates shapes of a plurality of partial regions of the object surface 10a by using a design value of the optical system corrected based on the error information of the optical system and by using a plurality of measured wavefronts of lights from the partial regions measured after the object surface 10a is driven (steps S115 and S116). Finally, the method stitches the shapes of the partial regions of the object surface 10a to calculate an entire shape of the object surface 10a. These calculations are performed by the analysis calculator 9 in the aspherical surface measurement apparatus 300.

Preferably, at the step (step S303) of calculating the error information of the optical system, the analysis calculator 9 performs a first ray tracing calculation by using the design value of the optical system, a design value of the first standard surface, and surface data of the first standard surface. Furthermore, the analysis calculator 9 performs a second ray tracing calculation by using the design value of the optical system, a design value of the second standard surface, and surface data of the second standard surface. Then, the analysis calculator 9 calculates the error information of the optical system based on the first wavefront, the second wavefront, a third wavefront (wavefront W₀₁) calculated by the first ray tracing calculation, and a fourth wavefront (wavefront W₀₂) calculated by the second ray tracing calculation.

While Embodiment 1 does not calibrate a rotationally symmetric error, this embodiment can calibrate the rotationally symmetric error. In addition, compared to Embodiment 2, this embodiment does not obtain the system error based on the difference between the partial measurement shape data for the overlapping regions, and therefore robustness is high. While a lens is used as an object in each of Embodiments 1 to 3, the object is not limited to the lens but a member such as a mirror and a mold having a shape equivalent to a shape of the lens can also be applied.

### Embodiment 4

Next, referring to FIG. 7, a processing apparatus of an optical element in Embodiment 4 of the present invention will be described. FIG. 7 is a schematic configuration diagram of a processing apparatus 400 of an optical element in this embodiment. The processing apparatus 400 of the optical element processes the optical element based on information from the aspherical surface measurement apparatus 100 in Embodiment 1 (or the aspherical surface measurement apparatus 300 in Embodiment 3).

In FIG. 7, reference numeral 20 denotes a material of the lens 10 (object), and reference numeral 401 denotes a processing device that performs a process such as cutting and polishing for the material 20 to manufacture the lens 10 as an optical element. The lens 10 in this embodiment has an aspherical shape.

A surface shape of the lens 10 (object surface 10a) processed by the processing device 401 is measured by using the aspherical surface measurement method described in any one of Embodiments 1 to 3 in the aspherical surface measurement apparatus 100 (or the aspherical surface measurement apparatus 300) as a measurer. In order to complete the object surface 10a to have a target surface shape, the aspherical surface measurement apparatus 100 calculates a corrected processing amount for the object surface 10a based on a difference between measured data and target data of the surface shape of the object surface 10a and outputs it to the processing device 401. Thus, the corrected processing is performed on the object surface 10a by using the processing device 401 and the lens 10 which has the object surface 10a having the target surface shape is completed.

According to each embodiment, an aspherical surface measurement method capable of performing stitching measurement of an aspherical shape having a large diameter with high accuracy, an aspherical surface measurement apparatus, a non-transitory computer-readable storage medium, a processing apparatus of an optical element, and the optical element can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the sensor of the aspherical surface measurement apparatus in each embodiment is configured to measure the reflected light from the object surface or the standard surface, but each embodiment is not limited thereto and alternatively it may be configured to measure transmitted light from the object surface or the standard surface. A non-transitory computer-readable storage medium which stores a program to cause a computer to execute the aspherical surface measurement method in each embodiment also constitutes one aspect of the present invention.

### OTHER EMBODIMENTS

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

This application claims the benefit of Japanese Patent Application No. 2014-138313, filed on Jul. 4, 2014, which is hereby incorporated by reference wherein in its entirety.

What is claimed is:

1. An aspherical surface measurement method comprising the steps of:
measuring a first wavefront of light from a standard surface having a known shape;
measuring a second wavefront of light from an object surface having an aspherical shape;
rotating the object surface around an optical axis and then measuring a third wavefront of light from the object surface;
calculating error information of an optical system based on the first wavefront, the second wavefront, and the third wavefront;
calculating shapes of a plurality of partial regions of the object surface by using a design value of the optical system corrected based on the error information of the optical system and by using a plurality of measured wavefronts of lights from the partial regions measured after the object surface is driven; and
stitching the shapes of the partial regions of the object surface to calculate an entire shape of the object surface.

2. The aspherical surface measurement method according to claim 1,
wherein the step of rotating the object surface includes rotating, within a range of 45 to 135 degrees around the optical axis, the object surface disposed at the step of measuring the second wavefront.

3. The aspherical surface measurement method according to claim 1,
wherein the step of rotating the object surface includes rotating, by 90 degrees around the optical axis, the object surface disposed at the step of measuring the second wavefront.

4. The aspherical surface measurement method according to claim 1,
wherein the step of calculating the error information of the optical system includes:
performing a ray tracing calculation by using the design value of the optical system, a design value of the standard surface, and surface data of the standard surface, and
calculating the error information of the optical system based on the first wavefront, the second wavefront, the third wavefront, and a fourth wavefront which is calculated by the ray tracing calculation.

5. An aspherical surface measuring method comprising the steps of:
measuring a first wavefront of light from a first standard surface having a first known shape;
measuring a second wavefront of light from a second standard surface having a second known shape;
calculating error information of an optical system based on the first wavefront and the second wavefront;
calculating shapes of a plurality of partial regions of the object surface by using a design value of the optical system corrected based on the error information of the optical system and by using a plurality of measured wavefronts of lights from the partial regions measured after the object surface is driven; and
stitching the shapes of the partial regions of the object surface to calculate an entire shape of the object surface.

6. The aspherical surface measurement method according to claim 5,
wherein the step of calculating the error information of the optical system includes:
performing a first ray tracing calculation by using the design value of the optical system, a design value of the first standard surface, and surface data of the first standard surface,
performing a second ray tracing calculation by using the design value of the optical system, a design value of the second standard surface, and surface data of the second standard surface, and
calculating the error information of the optical system based on the first wavefront, the second wavefront, a third wavefront which is calculated by the first ray tracing calculation, and a fourth wavefront which is calculated by the second ray tracing calculation.

7. The aspherical surface measurement method according to claim 1,
wherein the error information of the optical system contains error information of a rotationally asymmetric component of the optical system.

8. The aspherical surface measurement method according to claim 1,
wherein the error information of the optical system contains error information of a rotationally symmetric component of the optical system.

9. The aspherical surface measurement method according to claim 1,
wherein the step of calculating the shapes of the partial regions of the object surface includes performing drives including parallel movements, rotations, or tilts of the object surface a plurality of times, and measuring, as the measured wavefronts, wavefronts of lights from the partial regions of the object surface after each of the drives.

10. The aspherical surface measurement method according to claim 1,
wherein the step of calculating the shapes of the partial regions of the object surface includes:
determining a division condition of the object surface,
driving the object surface based on the division condition,
measuring the shapes of the partial regions of the object surface based on the measured wavefronts of the lights from the object surface, and
repeating the steps of driving the object surface and measuring the shapes of the partial regions of the object surface to acquire the measured wavefronts related to the partial regions which include regions overlapping with each other.

11. The aspherical surface measurement method according to claim 10,
wherein the step of measuring the shapes of the partial regions of the object surface includes:
illuminating, as illumination light that is a spherical wave, light from a light source onto the object surface, and guiding, as detection light, reflected light or transmitted light from the object surface to a sensor by using an imaging optical system, and
detecting, by using the sensor, the detection light guided by the imaging optical system.

12. An aspherical surface measurement apparatus comprising:
a detection unit configured to detect a wavefront of light;
a drive unit configured to rotate an object surface around an optical axis; and
a calculation unit configured to calculate a shape of the object surface based on an output signal of the detection unit,
wherein the calculation unit is configured to:
measure a first wavefront as a wavefront of light from a standard surface having a known shape,
measure a second wavefront as a wavefront of light from the object surface having an aspherical shape,
measure a third wavefront as a wavefront of light from the object surface rotated by the drive unit,
calculate error information of an optical system based on the first wavefront, the second wavefront, and the third wavefront,
calculate shapes of a plurality of partial regions of the object surface by using a design value of the optical system corrected based on the error information of the optical system and by using a plurality of measured wavefronts of lights from the partial regions measured after the object surface is driven, and
stitches the shapes of the partial regions of the object surface to calculate an entire shape of the object surface.

13. An aspherical surface measurement apparatus comprising:
a detection unit configured to detect a wavefront of light; and
a calculation unit configured to calculate a shape of the object surface based on an output signal of the detection unit,
wherein the calculation unit is configured to:
measure a first wavefront as a wavefront of light from a first standard surface having a first known shape,
measure a second wavefront as a wavefront of light from a second standard surface having a second known shape,
calculate error information of an optical system based on the first wavefront and the second wave front,
calculating shapes of a plurality of partial regions of the object surface by using a design value of the optical system corrected based on the error information of the optical system and by using a plurality of measured wavefronts of lights from the partial regions measured after the object surface is driven, and
stitching the shapes of the partial regions of the object surface to calculate an entire shape of the object surface.

14. The aspherical surface measurement apparatus according to claim 12,
wherein the optical system includes:
a half mirror configured to reflect light emitted from a light source,
a projection lens configured to converge light reflected by the half mirror, and
an imaging lens configured to guide the light reflected by the object surface to the detection unit via the projection lens and the half mirror.

15. A non-transitory computer-readable storage medium which stores a program to cause a computer to execute a process comprising the steps of:
measuring a first wavefront of light from a standard surface having a known shape;
measuring a second wavefront of light from an object surface having an aspherical shape;
rotating the object surface around an optical axis and then measuring a third wavefront of light from the object surface;
calculating error information of an optical system based on the first wavefront, the second wavefront, and the third wavefront;
calculating shapes of a plurality of partial regions of the object surface by using a design value of the optical system corrected based on the error information of the optical system and by using a plurality of measured wavefronts of lights from the partial regions measured after the object surface is driven; and
stitching the shapes of the partial regions of the object surface to calculate an entire shape of the object surface.

16. A processing apparatus of an optical element comprising:
an aspherical surface measurement apparatus; and
a processing device configured to process the optical element based on information output from the aspherical surface measurement apparatus,
wherein the aspherical surface measurement apparatus comprises:
a detection unit configured to detect a wavefront of light;
a drive unit configured to rotate an object surface around an optical axis; and
a calculation unit configured to calculate a shape of the object surface based on an output signal of the detection unit,
wherein the calculation unit is configured to:
measure a first wavefront as a wavefront of light from a standard surface having a known shape,
measure a second wavefront as a wavefront of light from the object surface having an aspherical shape,
measure a third wavefront as a wavefront of light from the object surface rotated by the drive unit,
calculate error information of an optical system based on the first wavefront, the second wavefront, and the third wavefront,
calculate shapes of a plurality of partial regions of the object surface by using a design value of the optical system corrected based on the error information of the optical system and by using a plurality of measured wavefronts of lights from the partial regions measured after the object surface is driven, and
stitches the shapes of the partial regions of the object surface to calculate an entire shape of the object surface.

17. An optical element manufactured by using a processing apparatus of the optical element,
wherein the processing apparatus comprises:
an aspherical surface measurement apparatus; and
a processing device configured to process the optical element based on information output from the aspherical surface measurement apparatus,
wherein the aspherical surface measurement apparatus comprises:
a detection unit configured to detect a wavefront of light;
a drive unit configured to rotate an object surface around an optical axis; and
a calculation unit configured to calculate a shape of the object surface based on an output signal of the detection unit,
wherein the calculation unit is configured to:
measure a first wavefront as a wavefront of light from a standard surface having a known shape,
measure a second wavefront as a wavefront of light from the object surface having an aspherical shape,
measure a third wavefront as a wavefront of light from the object surface rotated by the drive unit,
calculate error information of an optical system based on the first wavefront, the second wavefront, and the third wavefront,
calculate shapes of a plurality of partial regions of the object surface by using a design value of the optical system corrected based on the error information of the optical system and by using a plurality of measured wavefronts of lights from the partial regions measured after the object surface is driven, and
stitches the shapes of the partial regions of the object surface to calculate an entire shape of the object surface.
